(19) United States
(12) Patent Application Publication
(10) Pub. No.: US 2024/0076922 A1
(43) Pub. Date: Mar. 7, 2024

(54) Magnetic Closure Bumpers

(71) Applicant: Cortex, LLC, Knoxville, TN (US)

(72) Inventors: Rodney Napier, Knoxville, TN (US); Zachary P. Beard, Jefferson City, TN (US)

(73) Assignee: Cortex, LLC, Knoxville, TN (US)

(21) Appl. No.: 18/456,600

(22) Filed: Aug. 28, 2023

Related U.S. Application Data
(60) Provisional application No. 63/401,828, filed on Aug. 29, 2022.

(51) Int. Cl. E05F 5/02

(52) U.S. Cl. CPC E05F 5/02; E05Y 2201/46; E05Y 2900/20; E05Y 2900/602

(57) ABSTRACT

A magnetic closure bumper assembly is used in conjunction with a movable structure that engages a stationary structure. The magnetic bumper assembly includes a first closure bumper and a second closure bumper. The first closure bumper includes a first bumper casing in which a first magnet is disposed. The first bumper casing has a mounting surface configured for attachment to the movable structure and an engagement surface opposing the mounting surface. The second closure bumper includes a second bumper casing in which a second magnet is disposed. The second bumper casing has a mounting surface configured for attachment to the stationary structure and an engagement surface opposing the mounting surface. Magnetic attraction between the first and second magnets causes the first closure bumper to be attracted to the second closure bumper, thereby urging the engagement surface of the first bumper casing to removably contact the engagement surface of the second bumper casing as the movable structure is moved toward the stationary structure.

### FIELD

This invention relates to the field of door and furniture hardware. More particularly, this invention relates to a door or drawer closure mechanism that incorporates magnetic components.

### BACKGROUND

Doors today are often equipped with standard bumpers designed to provide a quiet closure. A chief complaint among these existing technologies is that they result in repeated drumming as the door comes to rest in a closed position or in vibration in the door itself, neither of which is particularly quiet.

### SUMMARY

The aforementioned problems and more are solved by the magnetic closure bumper system described herein. The system provides an aesthetically pleasing, functionally simple, yet highly effective solution designed to ensure a quiet, tight closure every time a door, drawer, chest lid, or other enclosure is closed. Moreover, the system is designed to work with many types of closures available on the market today.

As described herein, the system involves magnetic and/or ferromagnetic materials that are affixed to or embedded within various sliding or shutting components, including the frames, doors and drawers of cabinetry, the lids of chests, and other containers. The system is also designed to be highly customizable to fit each consumer's particular needs and circumstances, and to be adjustable based not only on the type of door or closure layout, but also on the consumer's desired positioning.

Embodiments described herein are directed to a magnetic closure bumper assembly for use in conjunction with a movable structure that engages a stationary structure. The magnetic bumper assembly comprises a first closure bumper and a second closure bumper. The first closure bumper includes a first bumper casing in which a first magnet is disposed. The first bumper casing has a mounting surface configured for attachment to the movable structure and an engagement surface opposing the mounting surface. The second closure bumper includes a second bumper casing in which a second magnet is disposed. The second bumper casing has a mounting surface configured for attachment to the stationary structure and an engagement surface opposing the mounting surface. Magnetic attraction between the first and second magnets causes the first closure bumper to be attracted to the second closure bumper, thereby urging the engagement surface of the first bumper casing to removably contact the engagement surface of the second bumper casing as the movable structure is moved toward the stationary structure.

In some embodiments, one or both of the first and second bumper casings have a semi-elliptical shape and one or both of the first and second magnets have a cylindrical shape.

In some embodiments, one or both of the first and second bumper casings have a semi-toroidal shape and one or both of the first and second magnets have an annular shape.

In some embodiments, the first and second bumper casings are formed from polyurethane.

In some embodiments, the first magnet is embedded within the first bumper casing and the second magnet is embedded within the second bumper casing.

In some embodiments, the force of magnetic attraction between the first magnet and the second magnet is adjustable based on selection of the thickness of the portion of the first bumper casing disposed between the first magnet and the engagement surface of the first bumper casing. Alternatively, the force of magnetic attraction between the first magnet and the second magnet is adjustable based on selection of the thickness of the portion of the second bumper casing disposed between the second magnet and the engagement surface of the second bumper casing.

In some embodiments, the engagement surface of the first bumper casing has a convex shape and the engagement surface of the second bumper casing has a concave shape that substantially matches the convex shape of the first bumper casing. In other embodiments, the engagement surface of the first bumper casing has a concave shape and the engagement surface of the second bumper casing has a convex shape that substantially matches the concave shape of the first bumper casing.

Some embodiments described herein are directed to a magnetic closure bumper assembly for use in conjunction with a movable structure that engages a stationary structure. The magnetic bumper assembly comprises a first closure bumper and a second closure bumper. The first closure bumper includes a first bumper casing in which a magnet is disposed. The first bumper casing has a mounting surface and an engagement surface opposing the mounting surface. The mounting surface is configured for attachment to the movable structure or to the stationary structure. The second closure bumper includes a second bumper casing in which a ferromagnetic structure is disposed. The second bumper casing has a mounting surface and an engagement surface opposing the mounting surface. The mounting surface is configured for attachment to the stationary structure or to the movable structure. The magnetic attraction between the magnet and the ferromagnetic structure causes the first closure bumper to be attracted to the second closure bumper, thereby urging the engagement surface of the first bumper casing to removably contact the engagement surface of the second bumper casing as the movable structure is moved toward the stationary structure.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1A depicts a front view of a magnetic closure bumper according to a first embodiment of the invention;

FIG. 1B depicts a side view of a magnetic closure bumper according to the first embodiment of the invention;

FIG. 1C depicts a cross section view of a magnetic closure bumper according to the first embodiment of the invention;

FIG. 2A depicts a front view of a magnetic closure bumper according to a second embodiment of the invention;

FIG. 2B depicts a side view of a magnetic closure bumper according to the second embodiment of the invention;

FIG. 2C depicts a cross section view of a magnetic closure bumper according to the second embodiment of the invention; and

FIG. 3 depicts a magnetic closure bumper assembly attached to a cabinet frame and door according to an embodiment of the invention.

### DETAILED DESCRIPTION

Embodiments described herein are directed to a small, low-profile system of magnetic closure bumpers. In some embodiments, the magnetic closure bumpers are attached to a movable structure that engages a stationary structure, such as a door and frame of a cabinet. The closure bumpers generally comprise one or more magnets and/or ferromagnetic materials encased in a relatively soft casing material allowing for a tight, quiet fit. Such casing materials might include polyurethane or other materials with such desirable properties.

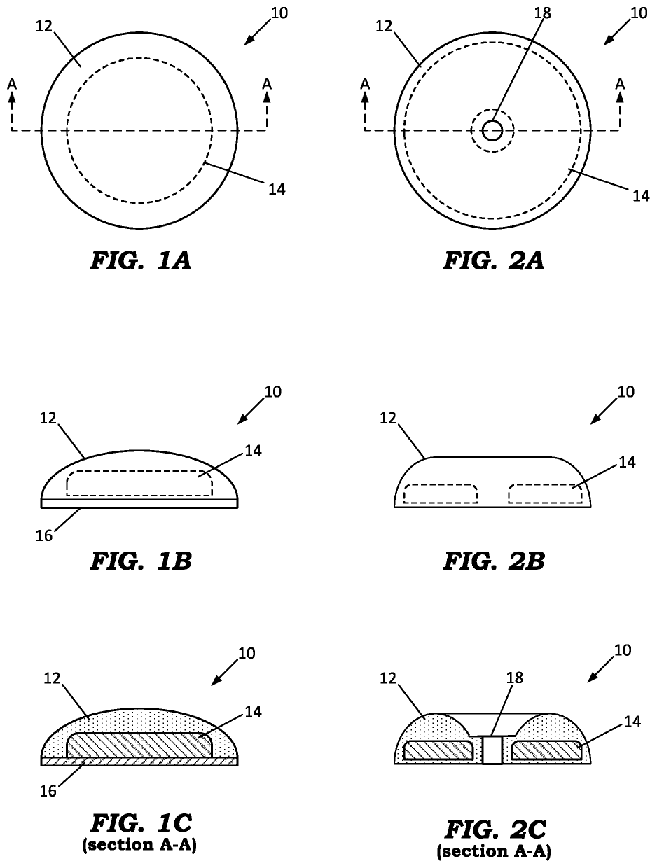

FIGS. 1A-1C and 2A-2C depict two embodiments of magnetic closure bumpers 10. As shown in FIGS. 1A-1C, a first embodiment comprises a bumper casing 12 having a semielliptical shape. A magnet 14 is disposed within the bumper casing 12. Preferably, the magnet 14 has a cylindrical puck shape, although other shapes are possible and may be preferable with other casing shapes. This embodiment includes an adhesive layer 16—such as a double-sided peel-and-stick adhesive—for attaching the bumper casing 12 to the movable or stationary structure.

As shown in FIGS. 2A-2C, a second embodiment comprises a bumper casing 12 having a semi-toroidal shape. A magnet 14 disposed within the bumper casing 12 preferably has a shallow annular shape, such as a washer shape, although other shapes are possible and may be preferable with other casing shapes. This embodiment includes a central aperture 18 passing through the casing 12 for receiving a bolt, screw, nail, rivet, or other similar fastener for attaching the bumper casing 12 to the movable or stationary structure.

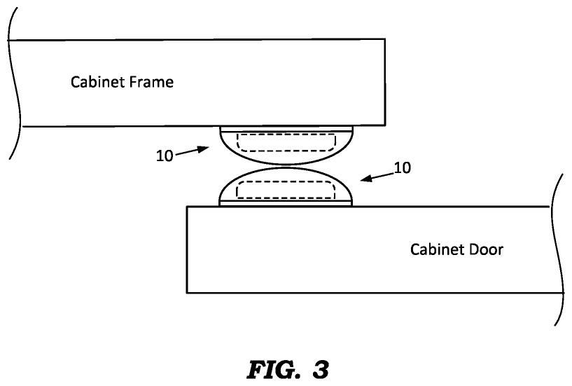

FIG. 3 depicts a pair of magnetic closure bumpers 10 attached to the frame and door of a cabinet. It will be appreciated that magnetic attraction between oppositely polarized magnets 14 causes the closure bumper 10 on the cabinet door to be attracted to the closure bumper 10 on the cabinet frame, thereby urging the engagement surface of each bumper casing 12 to removably contact the engagement surface of the other bumper casing 12 as the door is moved toward the frame. As shown in FIG. 3, it is preferable for the two bumpers 10 to be substantially aligned with each other when the door is in a closed position against the frame. This ensures that the magnetic force of attraction between the two bumpers 10 is maximized.

If the magnetic force of attraction between the two magnets 14 is properly adjusted, the force will be sufficient for the bumpers 10 to attract and engage each other without an undesirable bounce upon contact. The force of magnetic attraction upon contact may be adjusted based on selection of the thickness of the portion of the bumper casing 12 disposed between the magnet 14 and the engagement surface of the bumper casing. In preferred embodiments, a kit of bumpers 10 may be available to a consumer that includes bumpers having various thicknesses of casing material between the engagement surface and the magnet. In this way, the consumer may select a pair of bumpers 10 having the optimal combination of casing thicknesses for a particular application.

As the term is used herein, a ferromagnetic structure is a structure that contains or consists of a ferrous material or other material that is attracted to a magnet by magnetic force. As will be appreciated by one of ordinary skill in the art, a ferromagnetic material is a material having the same kind of magnetism as iron, such as a material that has high magnetic permeability and appreciable residual magnetism and hysteresis, or that possesses magnetization in the absence of an external magnetic field.

In an alternative embodiment, the magnet 14 in one of the two magnetic closure bumpers 10 shown in FIG. 3 is replaced by a ferromagnetic structure which may have substantially the same shape as the magnet. In this embodiment, the magnetic closure bumper 10 containing the magnet 14 may be attached to the frame and the magnetic closure bumper 10 containing the ferromagnetic structure may be attached to the door. Alternatively, the magnetic closure bumper 10 containing the ferromagnetic structure may be attached to the frame and the magnetic closure bumper 10 containing the magnet 14 may be attached to the door.

Typical existing bumper technologies create a closure that leaves a cabinet door slightly ajar due to the protrusion of the bumper. To cure this problem, each of the magnetic closure bumpers 10 depicted in FIG. 3 may be disposed in a recess in the surface of the door or in the surface of the frame or both. In this manner, the magnetic closure bumpers 10 are configured such that they are flush or nearly flush with the surface of the cabinet frame and/or door, so as to create a more complete closure between the frame and the door.

Some embodiments of the magnetic closure bumpers 10 are configured to incorporate a male/female design, wherein the forward surface of the bumper casing 12 on the frame (or door) has a convex (or concave) shape and the forward surface of the opposing bumper casing 12 on the door (or frame) has a matching concave (or convex) shape.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A magnetic closure bumper assembly for use in conjunction with a movable structure that engages a stationary structure, the magnetic bumper assembly comprising:
a first closure bumper comprising:
a first bumper casing having a mounting surface configured for attachment to the movable structure or to the stationary structure and an engagement surface opposing the mounting surface, wherein the engagement surface of the first bumper casing has a convex shape; and
a first magnet disposed within the first bumper casing; and
a second closure bumper comprising:
a second bumper casing having a mounting surface configured for attachment to the stationary structure or to the movable structure and an engagement surface opposing the mounting surface, wherein the engagement surface of the second bumper casing has a concave shape that substantially matches the convex shape of the first bumper casing; and
a second magnet disposed within the second bumper casing,
wherein magnetic attraction between the first and second magnets causes the first closure bumper to be attracted to the second closure bumper, thereby urging the engagement surface of the first bumper casing to removably contact the engagement surface of the second bumper casing as the movable structure is moved toward the stationary structure.

2. The magnetic closure bumper assembly of claim 1 wherein one or both of the first and second bumper casings have a semi-elliptical shape and one or both of the first and second magnets have a cylindrical shape.

3. The magnetic closure bumper assembly of claim 1 wherein one or both of the first and second bumper casings have a semi-toroidal shape and one or both of the first and second magnets have an annular shape.

4. The magnetic closure bumper assembly of claim 1 wherein the first and second bumper casings are formed from polyurethane.

5. The magnetic closure bumper assembly of claim 1 wherein the first magnet is embedded within the first bumper casing, and the second magnet is embedded within the second bumper casing.

6. The magnetic closure bumper assembly of claim 1 wherein a force of magnetic attraction between the first magnet and the second magnet is adjustable based on selection of a thickness of a portion of the first bumper casing disposed between the first magnet and the engagement surface of the first bumper casing, or based on selection of a thickness of a portion of the second bumper casing disposed between the second magnet and the engagement surface of the second bumper casing.

7. (canceled)

8. (canceled)

9. The magnetic closure bumper assembly of claim 1 wherein the mounting surface of the first bumper casing is configured to attach to a door or a drawer and the mounting surface of the second bumper casing is configured to attach to a door frame or a drawer frame.

10. A magnetic closure bumper assembly for use in conjunction with a movable structure that engages a stationary structure, the magnetic bumper assembly comprising:
a first closure bumper comprising:
a first bumper casing having a mounting surface configured for attachment to the movable structure or to the stationary structure and an engagement surface opposing the mounting surface, wherein the engagement surface of the first bumper casing has a convex shape or a concave shape; and
a magnet disposed within the first bumper casing; and
a second closure bumper comprising:
a second bumper casing having a mounting surface configured for attachment to the stationary structure or to the movable structure and an engagement surface opposing the mounting surface, wherein the engagement surface of the second bumper casing has:
a concave shape that substantially matches the convex shape of the first bumper casing, or
a convex shape that substantially matches the concave shape of the first bumper casing; and
a ferromagnetic structure disposed within the second bumper casing,
wherein magnetic attraction between the magnet and the ferromagnetic structure causes the first closure bumper to be attracted to the second closure bumper, thereby urging the engagement surface of the first bumper casing to removably contact the engagement surface of the second bumper casing as the movable structure is moved toward the stationary structure.

11. A magnetic closure bumper kit for use in conjunction with a movable structure that engages a stationary structure, the magnetic closure bumper kit comprising:
a first closure bumper comprising:
a first bumper casing having a mounting surface configured for attachment to the movable structure and an engagement surface opposing the mounting surface; and
a first magnet disposed within the first bumper casing,
wherein a portion of the first bumper casing disposed between the first magnet and the engagement surface of the first bumper casing has a first thickness;
a second closure bumper comprising:
a second bumper casing having a mounting surface configured for attachment to the movable structure and an engagement surface opposing the mounting surface; and
a second magnet disposed within the second bumper casing,
wherein a portion of the second bumper casing disposed between the second magnet and the engagement surface of the second bumper casing has a second thickness that is different from the first thickness; and
a third closure bumper comprising:
a third bumper casing having a mounting surface configured for attachment to the stationary structure and an engagement surface opposing the mounting surface; and
a third magnet disposed within the third bumper casing,
wherein attachment of the first closure bumper to the movable structure provides for magnetic attraction between the first and third magnets as the movable structure moves toward the stationary structure, which causes the first closure bumper to be attracted to the third closure bumper, thereby urging the engagement surface of the first bumper casing to removably contact the engagement surface of the third bumper casing, or
wherein attachment of the second closure bumper to the movable structure provides for magnetic attraction between the second and third magnets as the movable structure moves toward the stationary structure, which causes the second closure bumper to be attracted to the third closure bumper, thereby urging the engagement surface of the second bumper casing to removably contact the engagement surface of the third bumper casing, and
wherein, due at least in part to the difference between the first thickness and the second thickness, a force of magnetic attraction between first closure bumper and the third closure bumper is different from a force of magnetic attraction between second closure bumper and the third closure bumper.

12. A method for using the magnetic closure bumper kit of claim 12, comprising:
(a) making the magnetic closure bumper kit available to a consumer;
(b) the consumer attaching the third closure bumper to the stationary structure; and
(c) the consumer selecting either the first closure bumper or the second closure bumper for attachment to the movable structure,
wherein the force of magnetic attraction between the third closure bumper and the first or second closure bumper selected in step (c) is sufficient for attraction and engagement without an undesirable bounce upon contact.
